(19) United States
(12) Patent Application Publication
(10) Pub. No.: US 2002/0191702 A1
(43) Pub. Date: Dec. 19, 2002

(54) Method for transmitting data via a plurality of parallel data transmission links

(76) Inventor: Gerald Hoefer, Langerringen (DE)

Correspondence Address: JENKINS & WILSON, PA, 3100 TOWER BLVD, SUITE 1400, DURHAM, NC, 27707, US

(21) Appl. No.: 10/070,098

(22) PCT Filed: Dec. 1, 2000
(86) PCT No.: PCT/EP00/12117

(30) Foreign Application Priority Data
Dec. 2, 1999 (DE) 199 58 111.8

(51) Int. Cl. H04B 14/04

(52) U.S. Cl. 375/242

(57) ABSTRACT

The invention relates to a method for transmitting data between an analog modem (3) and a remote data terminal (4). The data can be transmitted at a variable sampling rate ≧8 kHz by means of a PCM modulation method from the analog modem (3) to a subscriber line module (5) that is provided with a coder/decoder device (50) with a corresponding sampling rate via an analog data transmission line (1). From the subscriber line module (5) at least two data transmission links K₁, K₂, . . . , Kₙ to the remote data terminal (4) can be established in parallel. The data transmission capacity properties of the data transmission line (1) during establishment of the link are determined. The maximally possible number mₘₐₓ of data symbols S_{xy} that can be transmitted per data transmission link K₁, K₂, . . . , Kₙ is determined. A certain number n of switched data transmission links K₁, K₂, . . . , Kₙ required for a predetermined data transmission rate is established on the basis of the data transmission capacity properties and the determined maximally possible number of transmittable data symbols S_{xy} per data transmission link K₁, K₂, . . . , Kₙ for producing a data transmission rate between the analog modem (3) and the remote data terminal (4) that is higher than 64 kbit/s.

The present invention relates to a method for transferring data using a Pulse Code Modulation method (abbreviated below to “PCM modulation method”) between an analogue modem and a data communication partner via a plurality of parallel data transmission links.

Although the method of the present invention can be applied to any methods for transferring data between a data terminal and a data communication partner, the present invention and the problems on which it is based are explained in relation to the transfer of data between an analogue modem and a digital communication partner, the latter being in the form of a dial-up point operating as a Central Side Modem (CSM).

For different types of information, such as speech, text, data, images, there are different standardized transmission services. The data terminal functions required for communication are incorporated into the standardization. A subscriber wishing to use a telecommunication service uses a data terminal as the access to the communication network. A data terminal is, by way of example, an analogue modem as the access to the World Wide Web. A data terminal is used either as a data source or as a data sink In particular, but not exclusively, high transfer rates are desirable when dealing with the Internet. Thus, in the case of an analogue modem connected to the telephone network using an analogue telephone line, the conventional maximum transfer rate of 64 kbit/s represents a severe restriction. This is because a user information channel in a telephone line merely provides a transfer rate with the theoretical boundary of 64 kbit/s in the telephone network, and a normal analogue modem supports only one channel or one data transmission link. For this reason, a few methods which can be used to attain higher transfer rates than 64 kbit/s are used.

One possibility for increasing the transfer rate is to use a plurality of parallel data transmission lines. To this end, however, a plurality of access points, corresponding to the number of data transmission lines required, need to be provided in one household, for example. This understandably represents an excessive cost factor and likewise an excessive work requirement.

The prior art comprises other approaches to transmitting higher transfer rates than 64 kbit/s. These are summarized under the generic term xDSL (x Digital Subscriber Line, such as ADSL (Asymmetrical Digital Subscriber Line), HDSL (High Bit Rate Digital Subscriber Line), ISDN (Integrated Services Digital Network), etc.).

In this context, one alternative is to use a baseband method having a high bandwidth and low modulation requirements, as in the case of ISDN, for example. ISDN is a digital communication system used throughout the world, in which analogue signals in a system input are subjected to analogue/digital conversion and are converted back to the analogue region at the system output.

The other alternative is to use the frequency range above 25 kHz with a dual-tone multifrequency method for the data transfer.

Data are transferred in digitalized systems preferably using a PCM modulation method. The PCM modulation method refers to a method in which the human voice, with a frequency band of 4 kHz, is sampled at 8 kHz according to Shannon's sampling theorem. The 8000 samples per second are respectively coded into 8 bits.

This results in a speech bit rate of 64 kbit/s, as is used on the user information channels in the ISDN telecommunication system. PCM systems are constructed and operated using digital technology. They afford a higher transfer quality as compared with analogue technology. Signals are transferred by sampling the incoming analogue signals at the transmission end using the sampling frequency of 8 kHz, quantizing them and supplying them to a coder. For the consecutive sampled amplitude values, the coder forms the associated code words which are transferred from the transmission point to the reception point. At the reception point, the transferred signals are decoded and are converted into a pulse-amplitude-modulated signal and demodulated.

A coder/decoder circuit (codec circuit) is thus an equipment unit of this type which carries out PCM coding in the outgoing direction and carries out PCM coding in the incoming direction.

Modems are equipment for transferring data signals via telephone channels using modulation.

The aforementioned methods for transferring data at a higher transfer rate than 64 kbit/s in accordance with the prior art all have the drawback, however, that they require a new “infrastructure”, i.e. that they place new demands and prerequisites on the data transfer network. In the case of the ISDN method, for example, these are that out-band signalling be supported in all switching centres so that the transferred data with a transfer rate of 64 kbit/s can be sent transparently through the entire data transfer network. In addition, in the case of the ADSL method, for example, it is necessary to provide a parallel network structure for transferring Internet Protocol (IP) packets to the end of the subscriber data transmission line so that, besides the classical data transfer switching, a data network is additionally set up in parallel with the data transfer switching. The approaches cited above also have the drawback that they have a particular data transfer rate, and this data transfer rate cannot match the demands placed on the transfer rate by a user according to area of application, since the sampling frequency of 8 kHz is not variable. Thus, the conduction properties are not taken into account previously either. A drawback of the known approaches above has thus been found to be the fact that the requirement of a new “infrastructure” holds a high cost and work requirement, that the data rate is not adaptive on account of the constant sampling rate of the appropriate components, and that the conduction situation is not taken into account at the same time.

Against this background, the invention is based on the object of providing a method for transferring data at a data transfer rate of higher than 64 kbit/s in which only one data transmission line with one data transfer access point is used, in which the data transfer is matched to the existing situation in the data transfer network, in order thus to achieve a predetermined data transfer rate via an analogue data transfer access point without changing the existing infrastructure, in which the data transfer rate is adaptive and in which the conduction situation is taken into account.

This object is achieved by the subject matter of claim 1.

The idea on which the invention is based is that of transferring data between an analogue modem and a data communication partner, where the data can be transferred, using a PCM modulation method, from the analogue modem with a variable sampling rate of greater than or equal to 8 kHz via an analogue data transmission line to a subscriber line unit which has a coder/decoder device with an appropriately variable sampling rate; and the subscriber line unit can set up at least two data transmission links to the data communication partner in parallel; having the following steps:

the data transfer conduction properties of the data transmission line are established during connection setup; the maximum possible number of data symbols which can be transferred per data transmission link is established; and a particular number, required for a predetermined data transfer rate, of connected data transmission links is set up on the basis of the data transfer conduction properties and the established maximum possible number of transferrable data symbols per data transmission link in order to produce a higher data transfer rate than 64 kbit/s between the analogue modem and the data communication partner. It is thus possible, without at all altering the existing data transfer network, to increase the data transfer rate, using an analogue data transmission line, as compared with the previous 64 kbit/s and to adjust it according to the situation on the data transmission line and the demands of the user, since it is possible to achieve an extension of the frequency band by changing the sampling rate.

In accordance with one preferred development, the data communication partner is preferably in the form of a digital modem. This may be in the digital communication partner, e.g. a Central Side Modem of an Internet provider.

In accordance with another preferred development, the subscriber line unit sets up the data transmission links required for a predetermined data transfer rate on the basis of the possible bandwidth of the data transmission line. The conduction properties are determined and the subscriber line unit is used to set up as many data transmission links as it takes to provide the required data transfer rate.

In accordance with another refinement, for each data transmission link, the amplitude values associated with the symbols to be transferred are respectively converted, with a matrix containing the amplitude values as matrix elements being able to be converted into a conversion table in the form of a consecutive serial listing to increase the respective maximum possible number of data symbols which can be transferred per data transmission link at a predetermined transmission power for the data transmission line. Particular elements in the data transfer network, such as attenuation elements, echo cancellers, RBS links, etc., have a restrictive effect on the transmission power of the data transfer network. These elements can thus cause noise or similar interference, in which case many symbols which are to be transferred cannot be allocated unequivocal amplitude values as a result. To close these “gaps”, the amplitude values associated with the symbols to be transferred are written from a matrix into a serial listing in a conversion table. This affords the advantage that the intervals between consecutive amplitude values are the same, and a particular number of data symbols can be transferred using a lower transmission power.

In accordance with another preferred development, the individual data transmission links can be forwarded to a data processing device, such as a personal computer (PC), associated with the analogue modem. This means that the user, for example when surfing the World Wide Web, can access a higher data transfer rate with his PC and can thus minimize irritating waiting times when loading particular Internet pages and during downloading.

In accordance with one preferred refinement, compensation for reception filters and clock recovery using a clock recovery device are effected directly in the analogue modem, with the clock signal for the analogue modem being able to be synchronized with the clock signal for the coder/decoder device in the subscriber line unit. The clock signal therefore need not be transferred at the same time, but rather the analogue modem itself is clocked in sync with the sample clock of the codec device. This reduces the volume of data to be transferred and ensures synchronous sampling.

An exemplary embodiment of the present invention is shown in the drawings and is explained in more detail in the description below. In the drawings:

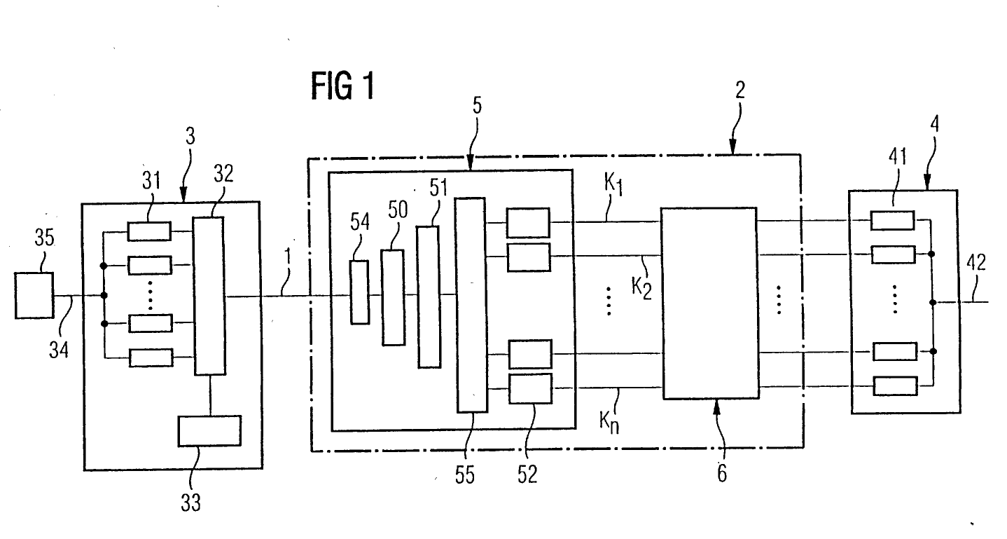

FIG. 1 shows a block diagram of the components involved in the data transfer in accordance with one exemplary embodiment of the present invention;

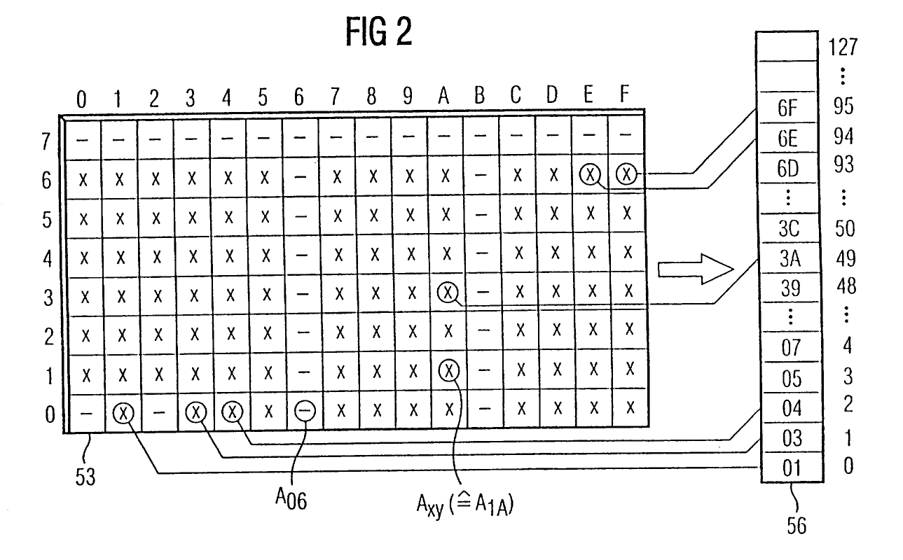

FIG. 2 shows an illustration of the amplitude values associated with the data symbols to be transferred being rewritten from a matrix into a serial listing in accordance with an exemplary embodiment of the present invention; and

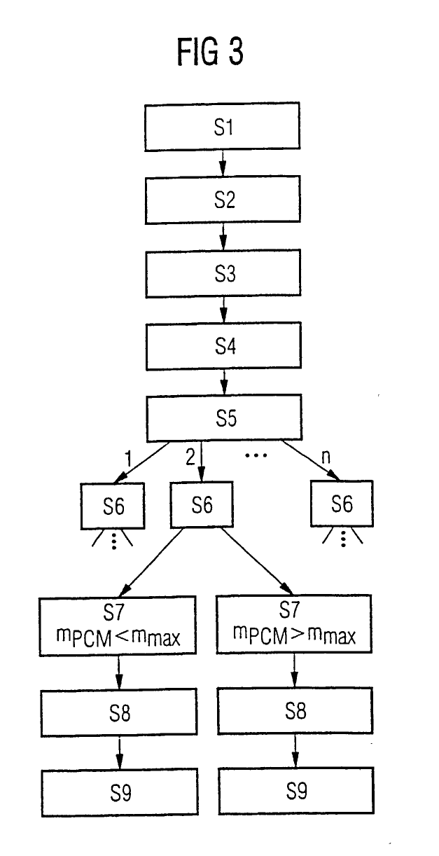

FIG. 3 shows a flowchart for the inventive method for increasing the data transfer rate using an analogue data transmission line in accordance with an exemplary embodiment of the present invention.

FIG. 1 shows a block diagram of the components involved in the method for transferring data in accordance with an exemplary embodiment of the present invention.

An analogue modem 3 is bidirectionally connected to a PC by means of an interface line using a DTE interface 34. Thus, by way of example, the data transferred from the modem 3 to the PC 35 are graphically displayed on a monitor using special software and hardware and provide the user with a utilizable representation of the required information.

At the modem end, single data transmission links K₁, K₂, . . . , Kₙ are forwarded together to the PC 35. For the purpose of using a plurality of data transmission links in parallel, a series of methods (e.g.: multilink PPP) are available.

The analogue modem 3 has a respective data coding/decoding device 31 for each data transmission link set up. This data coding/decoding device is a circuit which intrinsically combines the functions of a data-coding switching device and a data-decoding switching device. In this context, the data coding/decoding device 31 carries out PCM signal coding in the transmission direction and carries out PCM signal decoding in the reception direction.

The analogue modem 3 also has a modulator/demodulator circuit 32 for a higher frequency than 8 kHz. A modulator/demodulator circuit is a circuit which intrinsically combines the functions of a modulator switching device and a demodulator switching device. It is also called a modem circuit. In this context, the modem circuit carries out PCM modulation in the transmission direction and carries out PCM demodulation in the reception direction.

The analogue modem 3 can transfer signals in the frequency band between 0 kHz and an upper cut-off frequency, with other transmission techniques intervening and interfering above 25 kHz. In addition, the analogue modem 3 supports a plurality of parallel data transmission links K₁, K₂, . . . , Kₙ at the same time, each of these data transmission links (logical channels) having a flexible and individual data transfer rate of up to 64 kbit/s.

The analogue modem 3 can use a transmission technique which permits a flexible data transfer rate in the defined frequency band.

In addition, the analogue modem 3 also comprises a clock recovery device 33. This allows the modem 3 to synchronize with the variable sample clock of the data coding/decoding device 50 of a subscriber line unit 5 and to use precompensation to ensure that sample values are produced on the subscriber line unit 5 in the switching centre. The analogue modem 3 thus adjusts itself to the variable sample clock of the data coding/decoding device 50 of the subscriber line unit 5 both for the transmission direction and for the reception direction, and the clock signal does not need to be transferred at the same time. The analogue modem 3 likewise performs the compensation for the reception filters of the codec circuit. Hence, no clock recovery is carried out on the subscriber line unit 5, but rather clock synchronization is effected merely in the analogue modem 3.

The analogue modem 3 is connected to a data transfer system 2 by means of an analogue data transmission line 1.

The data transfer system 2 has a subscriber line unit 5 with an “SLIC” circuit 54 (SLIC: Subscriber Line Interface Circuit). This SLIC circuit 54 is in each case an integrated semiconductor chip for digital switching which performs the “BORSCHT” functions. “BORSCHT” is an invented word to cover the functions of a subscriber circuit in a switching centre. The initial letters of these functions form the word “BORSCHT”. The individual functions are Battery feed, Overvoltage protection, Ringing, Signalling, Coding, Hybrids and Testing. The subscriber line unit 5 also has a codec device 50 with a variable sampling rate, so that, in particular, it is also possible to sample using a frequency f≧8 kHz, a modulator/demodulator circuit 51 for supporting the transfer method between the subscriber line unit 5 and the analogue modem 3 with a higher frequency than 8 kHz, and a selection device 55 for selecting a particular number n of data transmission links K₁, K₂, . . . , Kₙ required for a predetermined data transfer rate according to the possible bandwidth f of the data transmission line 1 on the basis of the established, maximum possible number of transferrable data symbols S_{xy}.

The subscriber line unit 5 is designed such that it can independently set up any number of data transmission links and that the conduction properties of these n data transmission links K₁, K₂, . . . , Kₙ can be ascertained.

Each individual data transmission link K₁, K₂, . . ., Kₙ now has a respective associated conversion device 52 for converting the amplitude values associated with the symbols to be transferred from a matrix 53, as shown in FIG. 2, containing the amplitude values A_{xy} as matrix elements into a conversion table 56 in the form of a consecutive serial listing.

The n data transmission links K_{1, K}₂, . . . , Kₙ are connected to a data transfer network 6 together. The data transfer network 6 has, among other things, various interference elements, such as attenuation elements, echo cancellers, RBS links, etc., which result in a restriction in the transmission power of the data transfer network 6.

The data transfer network 6 in turn is connected to a data communication partner 4 via the n data transmission links K₁, K₂, . . . , Kₙ which have been set up, the data communication partner 4 being in the form of a digital modem 4, in accordance with the invention. This digital modem represents the dial-up point for a provider, for example. The digital modem 4 likewise has a respective data coding/decoding device 41 for each individual data transmission link K₁, K₂, . ., Kₙ set up, with the functions of such a data coding/decoding device which have already been described above.

Other connections to the digital modem 4 are produced using a DTE interface.

FIG. 2 shows the principle for converting the amplitude values A_{xy} associated with the symbols S_{xy} to be transferred, with the conversion of a matrix 53 containing the amplitude values A_{xy} as matrix elements into a conversion table 56 in the form of a consecutive serial listing being shown.

As already mentioned above, a voice signal is sampled in a data transmission link Kₓ using a sampling frequency of 8 kHz, since at least twice the clock rate of the frequency to be transferred needs to be used for sampling in order to ensure error-free data transfer, and is coded on the basis of its amplitude using a binary code. Thus, according to standard, a maximum of 256 different amplitude values per data channel can be stipulated. This 8-bit data value and a sampling frequency of 8 kHz produce the maximum data transfer rate for PCM signals for a data transmission link Kₓ of 64 kbit/s. The most significant bit characterizes the arithmetic sign, so that 128 amplitude values A_{xy} can be shown in the matrix 53.

Particular properties of the data transfer network 6, such as properties of the interference elements, have an adverse effect on the allocation of amplitude values A_{xy} to the data symbols S_{xy} which are to be transferred. This interference means that not all the PCM values can be used. These are identified by a minus in the matrix 53, in contrast to the possible PCM values which can be unequivocally assigned, which are identified by a cross in the matrix 53. Certain systematics mean that interference elements, such as attenuation elements, preferably have an effect at a particular column on account of an inaccuracy of calculation. These systematics are shown in the matrix 53 by the columns 6 and 8. Isolated PCM values may in the meantime also not be available on account of interference, however, such as the matrix element A₀₅.

The total transmission power of a data transmission link Kₓ is, as already mentioned, dependent on its respective properties. The total power of the data symbols S_{xy} to be transferred is made up of the sum of the individual amplitude values A_{xy}. Since only a limited transmission power is now available for the data transfer, the sum of these amplitude values needs to be kept as low as possible.

Since the matrix elements A_{xy} in the matrix 53 assume larger and larger amplitude values from left to right and from bottom to top, it is recommended that the matrix be converted into a “conversion table” 56 using a conversion device 52. In this context, the PCM values in the matrix 53 which are identified by a minus and cannot be used are omitted during transfer to the conversion table 56. This means that the total power of the amplitude values to be transferred can be reduced, since gaps in the amplitude values are removed and the total sum of the amplitude values is reduced if the intervals between the individual amplitude values remain the same. This is achieved by virtue of, for example, the amplitude value A₆ₑ initially not being allocated the 111th value, but in fact the 94th amplitude value on account of the omission of the PCM values which cannot be transferred. This means that the total sum of the amplitude values is reduced and it is possible to increase the transferrable data symbols Sₓ for a predetermined transmission power of the data transmission link Kₓ.

FIG. 3 shows a flowchart for the inventive method for increasing the data transfer rate in accordance with an exemplary embodiment of the present invention. In a step S1, a connection is set up between the analogue modem 3 and the digital modem 4 for the purpose of data transfer at a predetermined data transfer rate.

The analogue modem 3 and the data communication partner 4 agree on an algorithm which is used to convert the user data to PCM data and stipulates how these PCM values are connected to the subscriber line unit 5 via the data transfer network 6. Such methods are known as ITU-T Standard V.91.

In step S2, the subscriber line unit 5 is used to determine conduction properties of the data transmission line 1. This conduction situation is tested, by way of example, in the starter phase of the modem phase during connection setup using test symbols, and the possible bandwidth f of the line 1 is ascertained. The conduction quality also depends on the length of the line, among other things.

In addition, in step S3, the subscriber line unit 5 is used to establish, on the basis of the conduction situation, what the interval between two consecutive data symbols needs to be for clear distinction of these two data symbols. This means that the total transmission power of a data transmission link Kₓ and the interval between two consecutive data values are used as a basis for determining what maximum possible number mₘₐₓ of data symbols S_{xy} can be transferred per data transmission link K₁, K₂, . . . , Kₙ.

In step S4, to achieve the predetermined data transfer rate from step S1, an appropriate number of data transmission links K₁, K₂, . . . , Kₙ are set up to the data communication partner 4 using the subscriber line unit 5. These data transmission links are set up via the data transfer network 6 using a dialling method and are connected to the digital modem 4 via at least one data transmission line 1. Hence, the subscriber line unit 5 ultimately decides, on the basis of the possible bandwidth of the data transmission line 1, how many 64-kbit/s data transmission links K₁, K₂, . . . , Kₙ are necessary and possible for the predetermined data transfer rate. On the basis of this number, n data transmission links K₁, K₂, . . . , Kₙ to the digital modem 4 are then set up.

The data transfer between the analogue modem 3 and the digital modem 4 naturally works bidirectionally in a transmission direction and a reception direction.

Since the individual steps proceed analogously, the text below describes transfer of the data from the analogue modem 3 to the digital modem 4.

In step 5, the data to be transferred are coded in the analogue modem 3 using the data coding/decoding device 31 and are modulated for data transfer by a modulation method which uses PCM codes, using the modulator/demodulator circuit 32. The data stream is decoded into PCM values in the subscriber line unit 5. These PCM values correspond to the matrix elements A_{xy} in the matrix 53 from FIG. 2.

In the next step S6, the PCM values are respectively converted for each individual data transmission link K₁, K₂, . . . , Kₙ from the matrix notation to the serial representation from FIG. 2. More precisely, the analogue modem uses amplitude values for its own modulation, with these values being converted into pure amplitude values. These amplitude values are transferred via the analogue line and are recovered in the subscriber line unit 5. They now have the same values as in the analogue modem. The amplitude values are then converted into PCM values, with each amplitude value having precisely one associated PCM value. Next, the PCM values from the matrix are converted into the serial listing of the conversion table 56. Hence, each element of the serial listing has precisely one associated amplitude value in this case too, but the PCM values which are not unequivocal have already been removed and hence are not a useless contribution to the total transfer amplitude. For the conversion, the procedure for each individual data transmission link Kₓ is as below.

In step S7, a check is first carried out to determine whether the number of data symbols S_{xy} to be transferred is less than or greater than the number of possible PCM values.

If the number of possible PCM values is less than the maximum possible number mₘₐₓ of data symbols S_{xy} which can be transferred, then, in step S8, the PCM values are allocated to the transferrable data symbols S_{xy} and the conversion table is filled, starting with the smallest amplitude values and filling with rising amplitude values.

If, on the other hand, the number of PCM values is greater than the maximum possible number mₘₐₓ of data symbols S_{xy} which can be transferred, then, in step S8, the PCM values are likewise allocated to the data symbols S_{xy}, but only a maximum of mₘₐₓ PCM values are allocated to the symbols, and the data communication partner 4 is notified of this number of PCM values.

In the next step S9, the data transfer network 6 is used to perform the data transfer for the PCM values which are now in the conversion table 56 to the digital modem 4 and to recover the data sent originally.

To fall in line with the predetermined data transfer rate, which is higher than 64 kbit/s, the frequency range of the data transmission line 1 needs to be correspondingly higher than between 0 and 8 kHz. In addition, the sampling rate required increases. In the case of the method of the present invention, the subscriber line unit 5 can be used to set up any number of parallel data transmission links K₁, K₂, . . . , Kₙ, with the subscriber line unit 5 being able to use a variable sampling rate to deliver sample values, and thus adjusting itself to the demands required.

A normal telephone network operates using the frequency 8 kHz, i.e. a data value is transferred every 125 μs. If, by way of example, two data transmission links K₁ and K₂ are now set up, two values are transferred via the data transmission line 1 in 125 μs. The clock frequency is thus 16 kHz. If a third data transmission link K₃ is additionally set up at the same time, a frequency of 12 kHz would suffice. However, codec properties mean that this needs to occur at a frequency which corresponds to the next highest base—2 logarithm, in this example as 16 kHz. This scheme can be continued as desired by setting up any number of data transmission links K₁, K₂, . . . , Kₙ to achieve a predetermined data transfer rate and by virtue of the subscriber line unit 5 adjusting itself to the corresponding sampling frequency.

The advantage of the present invention is that the number n of data transmission links K₁, K₂, . . . , Kₙ to be set up can be matched to the conduction situation, and an adaptive data transfer rate can be produced without the need to change the existing conduction situation.

Although the present invention has been described above with reference to a preferred exemplary embodiment, it is not limited thereto but can be modified in a wide variety of ways.

In particular, the inventive method can also be used between two analogue modems. To this end, in FIG. 1, instead of the data communication partner 4, all the components situated on the left of the data transfer network 6 would need to be mirrored on the other side.

List of Reference Symbols

| | |
|---|---|
| 1 | Data transmission line |
| 2 | Data transfer system |
| 3 | Analogue modem |
| 4 | Data communication partner |
| 5 | Subscriber line unit |
| 6 | Data transfer network |
| 31 | Data coding/data decoding device per data |
| | channel |
| 32 | Modulator/demodulator circuit for f ≧ 8 kHz |
| 33 | Clock recovery device |
| 34 | Interface |
| 35 | Data processing device (PC) |
| 41 | Data coding/data decoding device per data |
| | channel |
| 42 | Interface |
| 50 | Coder/decoder device (codec) with f ≧ 8 kHz |
| 51 | Modulator/demodulator circuit for f ≧ 8 kHz |
| 52 | Conversion device |
| 53 | Matrix |
| 54 | SLIC circuit |
| 55 | Selection device |
| 56 | Conversion tables |
| n | Number of connected data transmission links |
| mₘₐₓ | Maximum possible number of transferrable data |
| | symbols |
| K₁, K₂, | Data transmission links |
| . . . , Kₙ | |
| Kₓ | An arbitrary data transmission link |
| f | Bandwidth |
| S_{xy} | Data symbol |
| A_{xy} | Amplitude value for the data symbol S_{xy} |

1. Method for transferring data between an analogue modem (3) and a data communication partner (4), where
the data can be transferred, using a PCM modulation method, from the analogue modem (3) with a variable sampling rate of greater than or equal to 8 kHz via an analogue data transmission line (1) to a subscriber line unit (5) which has a coder/decoder device (50) with an appropriately variable sampling rate; and
where the subscriber line unit (5) can set up at least two data transmission links (K₁, K₂, . . . , Kₙ) to the data communication partner (4) in parallel;
having the following steps:
the data transfer conduction properties of the data transmission line (1) are established during connection setup;
the maximum possible number mₘₐₓ of data symbols S_{xy} which can be transferred per data transmission link (K₁, K₂, . . . , Kₙ) is established; and
a particular number n, required for a predetermined data transfer rate, of connected data transmission links (K₁, K₂, . . . , Kₙ) is set up on the basis of the data transfer conduction properties and the established maximum possible number of transferrable data symbols S_{xy} per data transmission link (K₁, K₂, . . . , Kₙ) in order to produce a higher data transfer rate than 64 kbit/s between the analogue modem (3) and the data communication partner (4).

2. Method according to claim 1, characterized
in that the data communication partner (4) is in the form of a digital modem (4).

3. Method according to claim 1, characterized
in that the subscriber line unit (5) sets up the data transmission links (K₁, K₂, . . . , Kₙ) required for a predetermined data transfer rate on the basis of the possible bandwidth f of the data transmission line (1).

4. Method according to one of the preceding claims, characterized
in that, for each data transmission link (K₁, K₂, . . . , Kₙ), the amplitude values A_{xy} associated with the symbols S_{xy} to be transferred are respectively converted, with a matrix (53) containing the amplitude values A_{xy} as matrix elements being able to be converted into a conversion table (56) in the form of a consecutive serial listing to increase the respective maximum possible number mₘₐₓ of data symbols S_{xy} which can be transferred per data transmission link (K₁, K₂, . . . , Kₙ) at a predetermined transmission power for the data transmission line (1).

5. Method according to one of the preceding claims, characterized
in that the individual data transmission links (K₁, K₂, . . . , Kₙ) can be forwarded to a data processing device (35) associated with the analogue modem (3).

6. Method according to one of the preceding claims, characterized
in that compensation for reception filters and clock recovery using a clock recovery device (33) are effected directly in the analogue modem (3), with the clock signal for the analogue modem (3) being able to be synchronized with the clock signal for the coder/decoder device (50) in the subscriber line unit (5).
